(19) United States
(12) Patent Application Publication
(10) Pub. No.: US 2014/0375548 A1
(43) Pub. Date: Dec. 25, 2014

(54) METHOD OF PROCESSING INFORMATION AND ELECTRONIC DEVICE

(71) Applicant: Lenovo (Beijing) Co., Ltd., Beijing (CN)

(72) Inventor: Qiang Zhang, Beijing (CN)

(73) Assignee: Lenovo (Beijing) Co., Ltd., Beijing (CN)

(21) Appl. No.: 14/229,923

(22) Filed: Mar. 30, 2014

(30) Foreign Application Priority Data
Jun. 19, 2013 (CN) 201310245196.6
Jun. 19, 2013 (CN) 201310245313.9

(51) Int. Cl. G06F 3/03

(52) U.S. Cl. CPC G06F 3/03
USPC 345/156

(57) ABSTRACT

This application discloses a method of processing information and two electronic device, the method comprises: obtaining first gesture information of a first body when the first body is plugged into a second body, wherein the first gesture information is used to indicate a first direction of the first body; obtaining second gesture information of the second body, wherein the second gesture information is used to indicate a second direction of the second body; and determining, based on the first gesture information and the second gesture information, a plugging mode in which the first body is plugged into the second body, to obtain a first determination result, wherein the plugging mode is a normal plugging mode for indicating that a first front face is opposite to a second front face after the first body is plugged into the second body.

The present application claims the priority of Chinese Patent Application No. 201310245196.6, entitled as “Information processing method and electronic device”, and filed with the Chinese Patent Office on Jun. 19, 2013, and Chinese Patent Application No. 201310245313.9, entitled as “electronic device”, and filed with the Chinese Patent Office on Jun. 19, 2013, the contents of which are incorporated herein by reference in its entirety.

### FIELD OF THE APPLICATION

This application relates to the filed of electronic technology, and particularly to a method of processing information and an electronic device.

### BACKGROUND OF THE APPLICATION

With the rapid development of electronic technology, there continuously appear electronic devices with various functions, and these electronic devices are more and more humane, so that users can have better experience during use of the electronic device, in order to meet user's requirements on different usage of electronic products, integrating various functions together becomes the current development trend of electronic products. For example, current PC and tablets two-in-one, various usage modes are implemented by assembling and disassembling the display and the keyboard base, such as a normal laptop mode, a mode of a tablet computer, and would also form the different usage states when a display is normally plugged into or reversely plugged into a keyboard base.

Currently, for both usages in which a display is normally plugged into or reversely plugged into a keyboard base, a direction in which a display is inserted into a keyboard base is primarily confirmed by the selections of the users, the different functional configurations of the laptops are performed by users according to the different plugging directions.

### SUMMARY OF THE APPLICATION

It is provided a method of processing information and an electronic device in the embodiments of the application, for achieving the automatic identification of a direction in which the display is inserted into the keyboard base, in a pluggable laptop.

In an aspect, It is provided a method of processing information adapted to an electronic device by an embodiment of the application, the electronic device including a first body and a second body, the first body including a first front face and a first back face which are opposite to each other, the second body including a second front face and a second back face which are opposite to each other, and the first body being adapted to be plugged into the second body, wherein the method includes:

obtaining first gesture information of the first body when the first body is plugged into the second body, wherein the first gesture information is used to indicate a first direction of the first body;

obtaining second gesture information of the second body, wherein the second gesture information is used to indicate a second direction of the second body; and

determining, based on the first gesture information and the second gesture information, a plugging mode in which the first body is plugged into the second body, to obtain a first determination result, wherein the plugging mode is a normal plugging mode for indicating that the first front face is opposite to the second front face after the first body is plugged into the second body, or a reverse plugging mode for indicating that the first front face is opposite to the first back face after the first body is plugged into the second body.

Optionally, the obtaining the first gesture information of the first body may include obtaining a first direction of a first left side face or a first right side face of the first front face; and

the obtaining the second gesture information of the second body may include obtaining a second direction of a second left side face or a second right side face of the second body,

wherein if the first direction is the direction of the first left side face, the second direction is the direction of the second left side face.

Optionally, the determining, based on the first gesture information and the second gesture information, a plugging mode in which the first body is plugged into the second body, to obtain a first determination result may include:

based on the first direction and the second direction, determining whether the first direction is the same as or opposite to the second direction to obtain a second determination result; and

based on the second determination result, determining the plugging mode in which the first body is plugged into the second body, to obtain the first determination result,

wherein if the second determination result indicates that the first direction is the same as the second direction, the first determination result indicates that the plugging mode is the normal plugging mode; and

if the second determination result indicates that the first direction is opposite to the second direction, the first determination result indicates that the plugging mode is the reverse plugging mode.

Optionally, if the plugging mode is the normal plugging mode, the method may further include, after the determining, based on the first gesture information and the second gesture information, the plugging mode in which the first body is plugged into the second body, and obtaining the first determination result:

based on the first determination result, generating a first interface adjustment instruction to adjust a current user interface of the electronic device; and

executing the first interface adjustment instruction to adjust the current user interface into a first interface corresponding to the normal plugging mode.

Optionally, if the plugging mode is the reverse plugging mode, the method may further include, after the determining, based on the first gesture information and the second gesture information, the plugging mode in which the first body is plugged into the second body, and obtaining the first determination result:

based on the first determination result, generating a second interface adjustment instruction to adjust a current user interface of the electronic device; and

executing the second interface adjustment instruction to adjust the current user interface into a second interface corresponding to the reverse plugging mode.

In another aspect, it is further provided a first kind of electronic device in an embodiment of the application, including:

a first body including a first front face and a first back face which are opposite to each other;

a second body including a second front face and a second back face which are opposite to each other, wherein the first body is plugged into the second body;

a first direction sensor for obtaining first gesture information of the first body when the first body is plugged into the second body, wherein the first gesture information is used to indicate a first direction of the first body;

a second direction sensor for obtaining second gesture information of the second body, wherein the second gesture information is used to indicate a second direction of the second body; and

a processor for determining, based on the first gesture information and the second gesture information, a plugging mode in which the first body is plugged into the second body, to obtain a first determination result, wherein the plugging mode is a normal plugging mode for indicating that the first front face is opposite to the second front face after the first body is plugged into the second body, or a reverse plugging mode for indicating that the first front face is opposite to the first back face after the first body is plugged into the second body.

Optionally, the first direction sensor is adapted to obtain a first direction of a first left side face or a first right side face of the first front face; and

the second direction sensor is adapted to obtain a second direction of a second left side face or a second right side face of the second body,

wherein if the first direction is the direction of the first left side face, the second direction is the direction of the second left side face.

Optionally, the processor may include:

a first determining unit for determining, based on the first direction and the second direction, whether the first direction is the same as or opposite to the second direction to obtain a second determination result; and

a second determining unit for determining, based on the second determination result, the plugging mode in which the first body is plugged into the second body, to obtain the first determination result,

wherein if the second determination result indicates the first direction is the same as the second direction, the first determination result indicates that the plugging mode is the normal plugging mode; and

if the second determination result indicates that the first direction is opposite to the second direction, the first determination result indicates that the plugging mode is the reverse plugging mode.

Optionally, the electronic device may further include:

a first generating unit for generating, based on the first determination result, a first interface adjustment instruction to adjust a current user interface of the electronic device; and

a first adjusting unit for executing the first interface adjustment instruction to adjust the current user interface into a first interface corresponding to the normal plugging mode.

Optionally, the electronic device may further include:

a second generating unit for generating, based on the first determination result, a second interface adjustment instruction to adjust a current user interface of the electronic device; and

a second adjusting unit for executing the second interface adjustment instruction to adjust the current user interface into a second interface corresponding to the reverse plugging mode.

By providing a first kind of the electronic device in an embodiment of the application it is solved the technical problem in the prior art that a insertion direction can not be identified automatically during a process of inserting the laptop into the base, and it is achieved the technical effect of determining the direction in which the panel is inserted into the base automatically and accurately.

It is further provided with a second kind of the electronic device in an embodiment of the application:

an electronic device, including a base and an insertion module, wherein the electronic device further includes:

a first positioning structure arranged in a first position on the base, wherein the first position is in a first engaging area of the base at which the base is engaged with the insertion module when the insertion module is inserted into the base;

a second positioning structure arranged in a second position on the insertion module, wherein the second position is in a second engaging area of the inserting module at which the base is engaged with the insertion module, with the second position being corresponding to the first position; and

a determining unit connected to the first positioning structure or the second positioning structure,

wherein during the approaching of the insertion module to the base, when the distance between the first positioning structure and the second positioning structure is smaller than or equal to a distance threshold, or when an acting force applied to the first positioning structure or the second positioning structure is greater than or equal to an acting force threshold, the first positioning structure or the second positioning structure outputs a trigger signal, such that the determining unit determines a direction in which the insertion module is inserted into the base based on the trigger signal.

Optionally, the electronic device may further include: a storage unit connected to the determining unit, for pre-storing a corresponding relation between the trigger signal and the direction in which the insertion module is inserted into the base, such that the determining unit determines the direction in which the insertion module is inserted into the base based on the trigger signal, according to the corresponding relation.

Optionally, the first position is on a first side of the first engaging area, and the second position is on a second side of the second engaging area corresponding to the first position, such that: when the insertion module is engaged with the base in a first direction, the acting force applied to the first positioning structure or the second positioning structure is greater than or equal to the acting force threshold; and when the insertion module is engaged with the base in a second direction that is different from the first direction, the acting force applied to the first positioning structure or the second positioning structure is smaller than the acting force threshold.

Optionally, the first positioning structure is a switch, and the second positioning structure is a groove structure arranged at a surface of the second engaging area corresponding to the switch; or the second positioning structure is the switch, and the first positioning structure is the groove structure arranged at a surface of the first engaging area corresponding to the switch, wherein when the acting force applied to the switch is greater than or equal to the acting force threshold, the switch may output the trigger signal.

Optionally, the first positioning structure is an embedded switch, and the second positioning structure is a protruded structure corresponding to the embedded switch; or the second positioning structure is the embedded switch, and the first positioning structure is the protruded structure corresponding to the embedded switch, wherein when the acting force applied to the switch is greater than or equal to the acting force threshold, the switch may output the trigger signal.

Optionally, the first position is on a first side of the first engaging area, and the second position is on a second side of the second engaging area corresponding to the first position, such that; when the insertion module is engaged with the base in a first direction, the distance between the first position and the second position is smaller than or equal to the distance threshold; and when the insertion module is engaged with the base in a second direction that is different from the first direction, the distance between the first position and the second position is greater than the distance threshold.

Optionally, the first positioning structure is a magnetic inductor, and the second positioning structure is a magnetic member; or the second positioning structure is the magnetic inductor, and the first positioning structure is the magnetic member, wherein when the distance between the magnetic inductor and the magnetic member is smaller than or equal to the distance threshold, the magnetic inductor outputs the trigger signal.

Optionally, the first positioning structure is a radio frequency structure, and the second positioning structure is a radio frequency identifying structure; or the second positioning structure is the radio frequency structure, and the first positioning structure is the radio frequency identifying structure, wherein when the distance between the radio frequency identifying structure and the radio frequency structure is smaller than or equal to the distance threshold, the radio frequency identifying structure outputs the trigger signal.

Optionally, the first position is on a first middle position of the first engaging area, and the second position is on a second middle position of the second engaging area, wherein the first positioning structure or the second positioning structure is an asymmetric structure, such that: when the insertion module is engaged with the base in a first direction, the acting force applied to the first positioning structure or the second positioning structure is greater than or equal to the acting force threshold; and when the insertion module is engaged with the base in a second direction different that is from the first direction, the acting force applied to the first positioning structure or the second positioning structure is smaller than the acting force threshold.

Optionally, the first positioning structure is a switch, and the second positioning structure is an asymmetric structure corresponding to the switch; or the second positioning structure is the switch, and the first positioning structure is the asymmetric structure corresponding to the switch, wherein when the acting force applied to the switch is greater than or equal to the acting threshold, the switch outputs the trigger signal.

Optionally, the asymmetric structure is an asymmetric inverted trapezoidal structure, an asymmetric inverted stepped structure or an asymmetric inverted triangle structure.

The method of processing information and the first electronic device according to the embodiments of this application have at least the following technical effects or advantages.

(1) Since in the embodiment of this application, by obtaining the direction information about that the first body is plugged into the second body, determining and identifying a plugging mode in which the first body is plugged into the second body by comparing the direction information in which the first body is plugged into the second body, the technical problem for pluggable laptops in the prior art is solved that the insertion direction in which the display is inserted into the keyboard base can't be automatically identified, and the technical effect is obtained that the plugging mode can be automatically identified by electronic device according to the direction in which the first body is plugged into the second body.

(2) Since in the embodiment of this application, by employing the technical means that the operating mode of the laptops is adjusted respectively according to corresponding instruction information generated automatically according to corresponding plugging mode to adapt to the plugging mode after the plugging mode of the pluggable laptop is automatically identified by the system, the technical problem for pluggable laptop in the prior art is solved that the adjusting operating mode of the laptop as needed can't be timely implemented by obtaining the direction in which the display is inserted into the keyboard base, the technical effect is achieved that the laptops can perform adaptive adjustment of the operating mode, and the experience of the user is improved.

The second electronic device according to the embodiment of this application has at least the following technical effects or advantages.

1. In the electronic device according to the present invention, the first positioning structure is arranged on the base, the second positioning structure corresponding to the first positioning structure is arranged on the insertion module, and during the approaching of the insertion module to the base, the first positioning structure or the second positioning structure outputs a trigger signal under certain conditions, such that the determining unit is enabled to determine a direction in which the insertion module is inserted into the base based on the trigger signal, thereby the technical problem in the prior art is solved that a insertion direction can't be automatically identified as the tablet computer is inserted into the base, and the technical effect is obtained that a direction in which the tablet is inserted into the base is automatically and accurately determined.

2. In the electronic device according to the present invention, a first position where the first positioning structure being located is on a first side of the first engaging area, and a second position is on a second side of the second engaging area; alternatively, the first position is arranged at a first middle position of the first engaging area, and the second position is arranged at a second middle position of the second engaging area, thereby the technical effect is achieved that the appearance diversity of the first engaging area and the second engaging area is improved on the basis of determining the direction in which the tablet is inserted into the base automatically and accurately.

3. In the electronic device according to the present invention, the first positioning structure may be provided as a switch, radio frequency identifying structure or magnetic inductor and other structures, and the second positioning structure is provided as a corresponding structure; the first positioning structure can also be provided as a groove, protruded structure, the radio frequency structure, the magnetic member, or asymmetric structure and other structures, and the second positioning structure is provided as a corresponding structure, thereby the technical effect is achieved that the design diversity of the first positioning structure and the second positioning structure is improved on the basis of determining a direction in which the tablet is inserted into the base automatically and accurately.

### BRIEF DESCRIPTION OF THE DRAWINGS

FIG. 1 is a flowchart of a method of processing information according to an embodiment of this application;

FIG. 2 is a structural schematic view of a first electronic device according to an embodiment of this application;

FIG. 3 is a primary structural view of a second electronic device according to an embodiment of this application;

FIG. 4 is a schematic view showing a relationship between a first position and a second position in a first embodiment of the second electronic device;

FIG. 5 is a schematic view showing the first embodiment of the second electronic device in which a first positioning structure and a second positioning structure are switches;

FIG. 6 is a schematic view showing a second embodiment of the second electronic device in which the first positioning structure and the second positioning structure are respectively a magnetic member and a magnetic inductor; and

FIG. 7 is a schematic view showing a third embodiment of the second electronic device in which the first positioning structure or the second positioning structure is asymmetric structure.

### DETAILED DESCRIPTION OF THE APPLICATION

It is provided a method of processing information and an electronic device in the embodiment of this application, which can identify the insertion direction by which the display is inserted into the keyboard base automatically.

A method of processing information is provided in the embodiment of this application, the method is applied to an electronic device, the electronic device including a first body and a second body, the first body including a first front face and a first back face which are opposite to each other, the second body including a second front face and a second back face which are opposite to each other, and the first body being adapted to be plugged into the second body, wherein the method includes:

obtaining first gesture information of the first body when the first body is plugged into the second body, wherein the first gesture information is used to indicate a first direction of the first body; obtaining second gesture information of the second body, wherein the second gesture information is used to indicate a second direction of the second body; and determining, based on the first gesture information and the second gesture information, a plugging mode in which the first body is plugged into the second body, to obtain a first determination result, wherein the plugging mode is a normal plugging mode for indicating that the first front face is opposite to the second front face after the first body is plugged into the second body, or a reverse plugging mode for indicating that the first front face is opposite to the first back face after the first body is plugged into the second body.

As can be seen, by obtaining the direction information about that the first body is plugged into the second body in the embodiment of this application, and employing the technical means that a plugging mode in which the first body is plugged into the second body is determined and identified by comparing the direction information about that the first body is plugged into the second body, the technical problem of pluggable laptops in the prior art is solved that the insertion direction in which the display is inserted into the keyboard base can't be automatically identified, and the technical effect is obtained that the plugging mode can be automatically identified by electronic device according to the direction by which the first body is plugged into the second body.

In order to better understand the above technical solutions, the above technical solutions will be described in detail with reference to the attached drawings and specific embodiments, it is to be understood that the embodiments of this application and the specific features in the embodiments are intended to explain in detail the technical solutions herein, rather than intended to define the technical solutions, the embodiments of this application and the technical features in the embodiments may be combined with one another without conflict.

An electronic device to which a method of processing information provided in the embodiments of this application may be applied generally refers to an electronic device which have a first body and a second body, the first body and the second body each includes a front face and a back face, and the first body may be plugged into the second body, such electronic device is a pluggable laptop, and PC two-in-one, the first body is a display, the second body is a keyboard base.

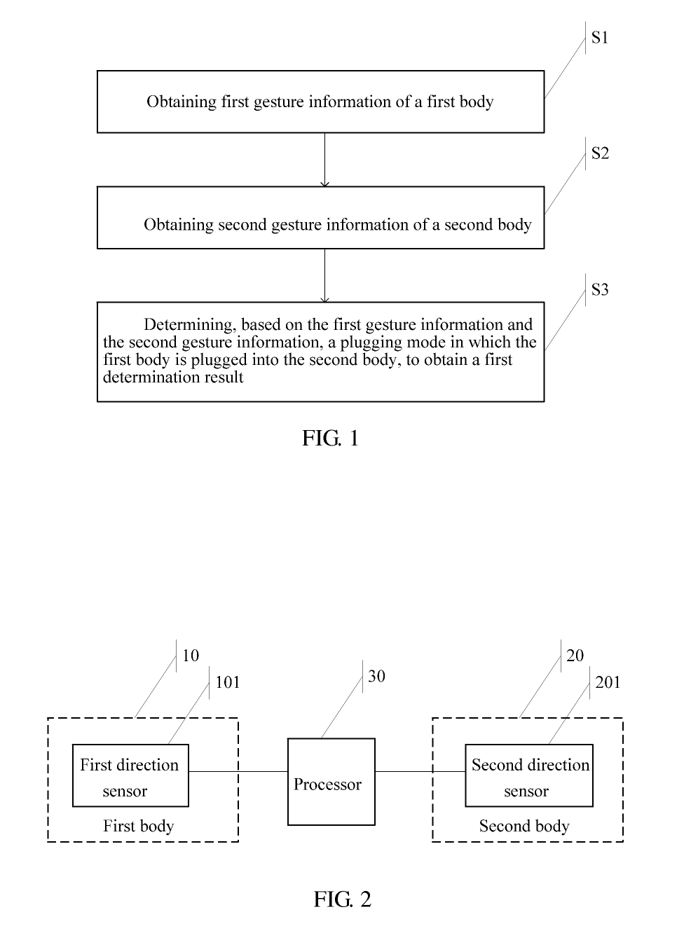

As shown in FIG. 1, a method of processing information provided in the embodiments of this application specifically includes steps S1 to S3.

S1: obtaining first gesture information of the first body when the first body is plugged into the second body, wherein the first gesture information is used to indicate a first direction of the first body.

S2: obtaining second gesture information of the second body, wherein the second gesture information is used to indicate a second direction of the second body.

In a particular implementation, taking pluggable laptop as an example to illustrate, the system obtains the first gesture information of a display and the second gesture information of a keyboard base by a sensor when the display is plugged into the keyboard base, the first gesture information and the second gesture information may refer to direction information, angle information, and relative position information of the display and the keyboard base in a specific embodiment. In the most preferred embodiment provided herein, where the gesture information mainly refers to a first direction of the display and a second direction of the keyboard base obtained by a direction sensor.

Further, the obtaining the first gesture information of the first body includes obtaining a first direction of a first left side face or a first right side face of the first front face; and

the obtaining the second gesture information of the second body includes obtaining a second direction of a second left side face or a second right side face of the second body.

Wherein when the first direction is the direction of the first left side face, the second direction is the direction of the second left side face.

In a particular implementation, when a first direction and a second direction in which the display is plugged into the keyboard base is obtained by the direction sensor in the system, the first direction obtained by the direction sensor refers specifically to the direction of the left or right side of the front face of the display (i.e. the display panel), and the second direction refers specifically to the direction of the left or right side of the front face of the keyboard base (i.e. the key surface). When the first direction of the display obtained by the direction sensor is specifically the direction of the left side face of the front face of the display, the second direction of the keyboard base obtained correspondingly is the direction of the left side face of the front face of the keyboard base; and when the first direction is specifically the direction of the right side face of the front face of the display, the second direction obtained is specifically the direction of the right side face of the front face of the keyboard base. The direction sensors used in the examples of this application may be any sensors which can obtain the direction of the side face of the display and the keyboard base, such as gyroscopes, or gravity sensors.

S3: determining, based on the first gesture information and the second gesture information, a plugging mode in which the first body is plugged into the second body, to obtain a first determination result, wherein the plugging mode is a normal plugging mode for indicating that the first front face is opposite to the second front face after the first body is plugged into the second body, or a reverse plugging mode for indicating that the first front face is opposite to the first back face after the first body is plugged into the second body.

Further, step S3 specifically includes:

based on the first direction and the second direction, determining whether the first direction is the same as or opposite to the second direction, to obtain a second determination result; and

based on the second determination result, determining the plugging mode in which the first body is plugged into the second body, to obtain a first determination result;

wherein if the second determination result indicates that the first direction is the same as the second direction, the first determination result indicates the plugging mode is the normal plugging mode; and

if the second determination result indicates that the first direction is opposite to the second direction, the first determination result indicates the plugging mode is the reverse plugging mode.

In the process of implementation, after the display has plugged into the keyboard base, and the system has obtained the first direction of display and the second direction of the keyboard base by direction sensor, the description is given here by way of an example that the first direction is the direction of left side face of the display front face and the second direction is the direction of left side face of the keyboard base front face, the system obtains the second determination result by determining whether the first direction is the same as the second direction based on the directions of the first direction and the second direction, and then the system obtains the first determination result by determining the plugging mode of display and keyboard base based on the second determination result. If the second determination result indicates that the direction of left side face of the front face of the display is the same as the direction of the left side face of the front face the keyboard base, the first determination result obtained by the system indicates that the plugging mode of the display and the keyboard base is the normal plugging mode, i.e., a plugging mode in which the front face of the display is opposite to the front face of the keyboard base, and if the second determination result indicates that the direction of left side face of the front face of the display is not the same as the direction of the left side face of the front face the keyboard base, the first determination result obtained by the system indicates that the plugging mode of the display and the keyboard base is the reverse plugging mode, i.e., the back face of the display is opposite to the front face of the keyboard base.

Further, when the plugging mode is the normal plugging mode, the method further includes, after step S3: based on the first determination result, generating a first interface adjustment instruction to adjust the current user interface of the electronic device; and executing the first interface adjustment instruction to adjust the current user interface into a first interface corresponding to the normal plugging mode.

Further, when the plugging mode is the reverse plugging mode, the method further includes, after step S3: based on the first determination result, generating a second interface adjustment instruction to adjust the current user interface of the electronic device; and executing the second interface adjustment instruction to adjust the current user interface into a second interface corresponding to the reverse plugging mode.

In the process of implementation, after the system has obtained the first determination result for indicating the plugging mode of the display and the keyboard base, the system generates a corresponding instruction information, e.g., an adjustment instruction to adjust the current user interface of a notebook computer, based on the first determination result, and then the current user interface is adjusted into a user interface corresponding to the normal plugging mode or the reverse plugging mode by executing a corresponding adjustment instruction. When the plugging mode of display and keyboard base switches between the normal plugging mode and the reverse plugging mode, the system also correspondingly adjust the user interface of the display between a first interface and a second interface. The instruction information generated by the system also specifically refers to a control instruction for the application program in the control system. For example, when the system determines that the display and keyboard base are in the reverse plugging mode, the system here may generate a control instruction to make the keyboard base enter into a standby mode. Generally, when the user uses the reverse plugging mode of the notebook computer, only the function of the display is used, and the keyboard merely acts as a base for supporting the display. As a result, the input function of the keyboard may be closed here, and the keyboard base enters into the standby mode. Of course, other control instructions may also be generated, such as, a camera is activated to detect whether a user is using the keyboard, and further determine whether the input function of the keyboard shall be closed.

It is clear that, in the embodiment of the present application, by employing the technical means that the operating mode of the laptops is adjusted respectively according to corresponding instruction information generated automatically according to corresponding plugging mode to adapt to the plugging mode after the plugging mode of the pluggable laptop is automatically identified by the system, the technical problem of pluggable laptop in the prior art is solved that adjusting operating mode of the laptop as needed can't be timely implemented by obtaining the direction in which the display is inserted into the keyboard base, the technical effect is achieved that the laptops perform adaptive adjustment to the operating mode, and the experience of the user is improved.

The way mentioned in the embodiment of the present application that the directions of the display of the notebook computer and of the keyboard base are obtained by direction sensor and then the plugging mode of the notebook computer is determined based on the direction is merely one way to recognize the plugging mode of the notebook computer. In the specific application, the plugging mode of the notebook computer also can be determined by an angle between the display and the keyboard base detected by an angular sensor, or can be determined by a relative position relation between the display and the keyboard base detected by a position sensor. For example, the gyroscope mentioned in the above embodiment of the present application may act as a direction sensor, and also as an angular sensor. After the angle between the display and the keyboard base is obtained, it can be known that if the angle between the display and the keyboard base is greater than 90 degree (i.e., the normal using mode in which the display is opposite to the keyboard base), the plugging mode is determined as the normal plugging mode, and if the angle between the display and the keyboard base is smaller than 90 degree (i.e., the back of the display is opposite to the keyboard base), the plugging mode is determined as the reverse plugging mode.

Based on the same inventive concept, an electronic device is provided in the embodiment of the present application, as shown in FIG. 2, specifically including:

a first body 10 having a first front face and a first back face which are opposite to each other;

a second body 20 having a second front face and a second back face which are opposite to each other, the first body can be plugged into the second body;

a first direction sensor 101 for acquiring a first gesture information of the first body when the first body is plugged into the second body, wherein the first gesture information is used to indicate a first direction of the first body;

a second direction sensor 201 for acquiring a second gesture information of the second body, wherein the second gesture information is used to indicate a second direction of the second body; and

a processor 30 for determining, based on the first gesture information and the second gesture information, the plugging mode in which the first body is plugged into the second body, to obtain a first determination result, wherein the plugging mode is a normal plugging mode for indicating that the first front face is opposite to the second front face after the first body is plugged into the second body; or the plugging mode is a reverse plugging mode for indicating that the first front face is opposite to the first back face after the first body is plugged into the second body.

Further, the first direction sensor is specifically adapted to obtain a first direction of a first left side face or a first right side face of the first front face; and

the second direction sensor is specifically adapted to obtain a second direction of a second left side face or a second right side face of the second body.

Wherein when the first direction is the direction of the first left side face, the second direction is the direction of the second left side face.

Further, the processor further includes:

a first determining unit for determining, based on the first direction and the second direction, whether the first direction is the same as or opposite to the second direction, to obtain a second determination result; and

a second determining unit for determining, based on the second determination result, the plugging mode in which the first body is plugged into the second body, to obtain a first determination result,

where if the second determination result indicates that the first direction is the same as the second direction, the first determination result indicates that plugging mode is the normal plugging mode; and

if the second determination result indicates that the first direction is opposite to the second direction, the first determination result indicates that the plugging mode is the reverse plugging mode.

Further, the electronic device further includes:

a first generating unit for generating, based on the first determination result, a first interface adjustment instruction to adjust the current user interface of the electronic device; and

a first adjusting unit for executing the first interface adjustment instruction to adjust the current user interface into a first interface corresponding to the normal plugging mode.

Further, the electronic device further includes:

a second generating unit for generating, based on the first determination result, a second interface adjustment instruction, to adjust the current user interface of the electronic device; and

a second adjusting unit for executing the second interface adjustment instruction to adjust the current user interface into a second interface corresponding to the reverse plugging mode.

It is further provided a second electronic device in the present invention, including a base and an insertion module, wherein the electronic device further includes:

a first positioning structure arranged in a first position on the base, wherein the first position is specifically located in a first engaging area of the base at which the base is engaged with the insertion module when the insertion module is inserted into the base;

a second positioning structure arranged in a second position on the insertion module, wherein the second position is specifically located in a second engaging area of the insertion module at which the base is engaged with the insertion module, with the second position corresponding to the first position; and

a determining unit connected to the first positioning structure or the second positioning structure,

wherein during the approaching of the insertion module to the base, when the distance between the first positioning structure and the second positioning structure is smaller than or equal to a distance threshold, or when acting force applied to the first positioning structure or the second positioning structure is greater than or equal to an acting force threshold, the first positioning structure or the second positioning structure outputs a trigger signal, such that the determining unit determines a direction in which the insertion module is inserted into the base based on the trigger signal.

It can be seen from the above that the first positioning structure is arranged on the base, the second positioning structure corresponding to the first positioning structure is arranged on the insertion module, and during the approaching of the insertion module to the base, the first positioning structure or the second positioning structure outputs a trigger signal under certain conditions, such that the determining unit is enabled to determine a direction in which the insertion module is inserted into the base based on the trigger signal, thereby the technical problem is solved that a insertion direction can't be automatically identified in the prior art during inserting the tablet computer into the base, and the technical effect is obtained that a direction in which the tablet is inserted into the base is automatically and accurately determined.

### FIRST EMBODIMENT

An electronic device is provided in the first embodiment, including a base and an insertion module, in practical application, the electronic device is a pluggable mobile phone, a pluggable laptop and the like, which will not be listed in the embodiment.

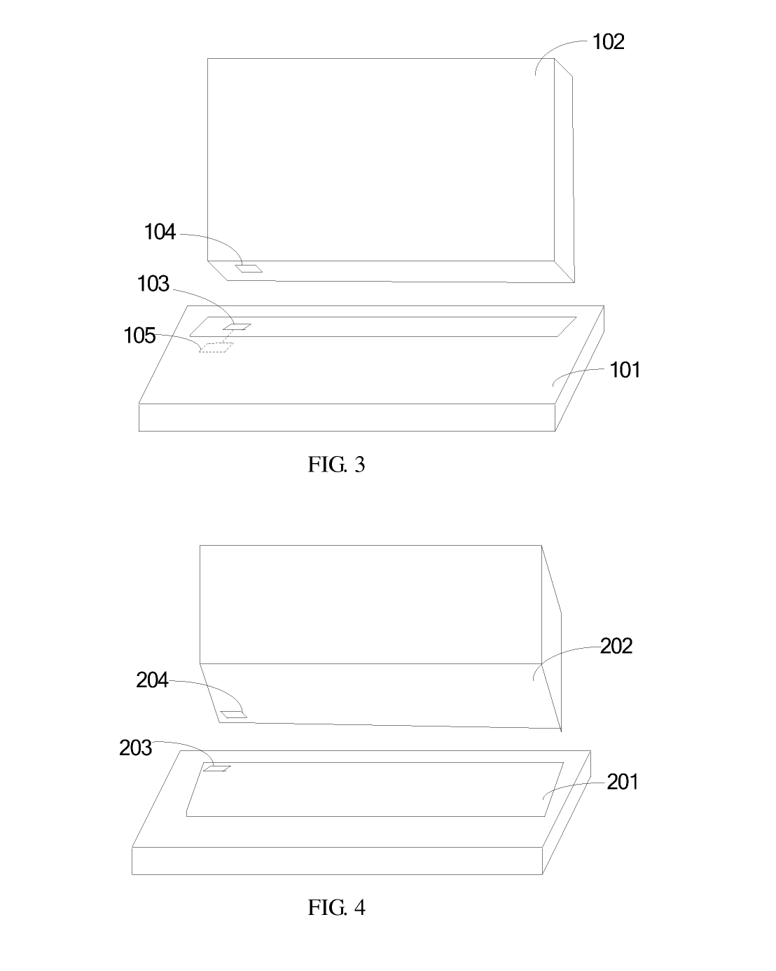

Referring to FIG. 3, in which the mainly structure of the electronic device in the first embodiment of the application is shown, the electronic device includes a base 101 and an insertion module 102, and further includes:

a first positioning structure 103 arranged in a first position on the base 101, wherein the first position is in a first engaging area of the base 101 at which the first base 101 is engaged with the insertion module 102 when the insertion module 102 is inserted into the base 101;

a second positioning structure 104 arranged in a second position on the insertion module 102, wherein the second position is in a second engaging area of the inserting module 102 at which the base 101 is engaged with the insertion module 102, with the second position being corresponding to the first position; and

a determining unit 105 connected to the first positioning structure 103 or the second positioning structure 104,

wherein during the approaching of the insertion module 102 to the base 101, when the distance between the first positioning structure 103 and the second positioning structure 104 is smaller than or equal to a distance threshold, or when acting force applied to the first positioning structure 103 or the second positioning structure 104 is greater than or equal to an acting force threshold, the first positioning structure 103 or the second positioning structure 104 outputs a trigger signal, such that the determining unit 105 may determine the direction in which the insertion module 102 is inserted into base 101 based on the trigger signal.

In the specific implementation process, a fixed structure may be arranged on the first engaging area of the base 101 and on the second engaging area of the insertion module 102 for connecting the fixed base 101 and insertion module 102, two of which are listed as follows.

A, a groove bayonet is arranged in the first engaging area, and a protruded fixture block corresponding to the groove bayonet is arranged in the second engaging area, the insertion module 102 can be fixed on the base 101 either through the whole base of the insertion module 102 via the engagement of the protrude fixture block and groove bayonet, or the engagement of the groove bayonet and the whole base of the insertion module 102. Alternatively, the groove bayonet is arranged in the second engaging area, the protruded fixture block corresponding to the groove bayonet is arranged in the first engaging area.

B, multiple of groove bayonets are arranged in the first engaging area, and multiple of protruded fixture blocks corresponding to groove bayonets are arranged in the second engaging area, the insertion module 102 can be fixed on the base 101 though the engagement of multiple of protruded fixture blocks and multiple of groove bayonets. Alternatively, multiple of groove bayonets are arranged in the second engaging area, multiple of protruded fixture blocks corresponding to groove bayonets are arranged in the first engaging area.

In the embodiment of the present invention, the electronic device further includes: a storage unit connected to the determining unit 104, for pre-storing a corresponding relation between the trigger signal and the direction in which the insertion module is inserted into the base, such that the determining unit 104 can determine the direction in which the insertion module 102 is inserted into the base 101, according to the corresponding relation based on the trigger signal.

Specifically, the items which may be pre-arranged and stored in the store unit are as follows: when the insertion module is engaged with the base, if the first positioning structure or the second positioning structure outputs a trigger signal, the direction of the engagement of the insertion module and base is a first direction; if the first positioning structure or the second positioning structure does not output the trigger signal, the direction of the engagement of the insertion module and the base is a second direction, and vice versa.

In the embodiment of the present invention, the first position is on the first side of the first engaging area, and the second position is on the second side of the second engaging area corresponding to the first position, such that: when the insertion module is engaged with the base in a first direction, the acting force applied to the first positioning structure or the second positioning structure is greater than or equal to the acting force threshold; and when the insertion module is engaged with the base in a second direction that is different from the first direction, the acting force applied to the first positioning structure or a second positioning structure is smaller than the acting force threshold.

Specially, the first position is arranged in any position on one side of the first engaging area, referred to FIG. 4, the first position may be arranged on any side of the first engaging area 201, such as at 203, the second position may be at 204 on the second engaging area 202 corresponding to 203.

In the embodiment of the present invention, the first positioning structure is a switch, and the second positioning structure is a groove structure arranged on a surface of the second engaging area corresponding to the switch; or the second positioning structure is the switch, and the first positioning structure is the groove structure arranged at a surface of the first engaging area corresponding to the switch. Wherein when the acting force applied to the switch is greater than or equal to the acting force threshold, the switch outputs the trigger signal.

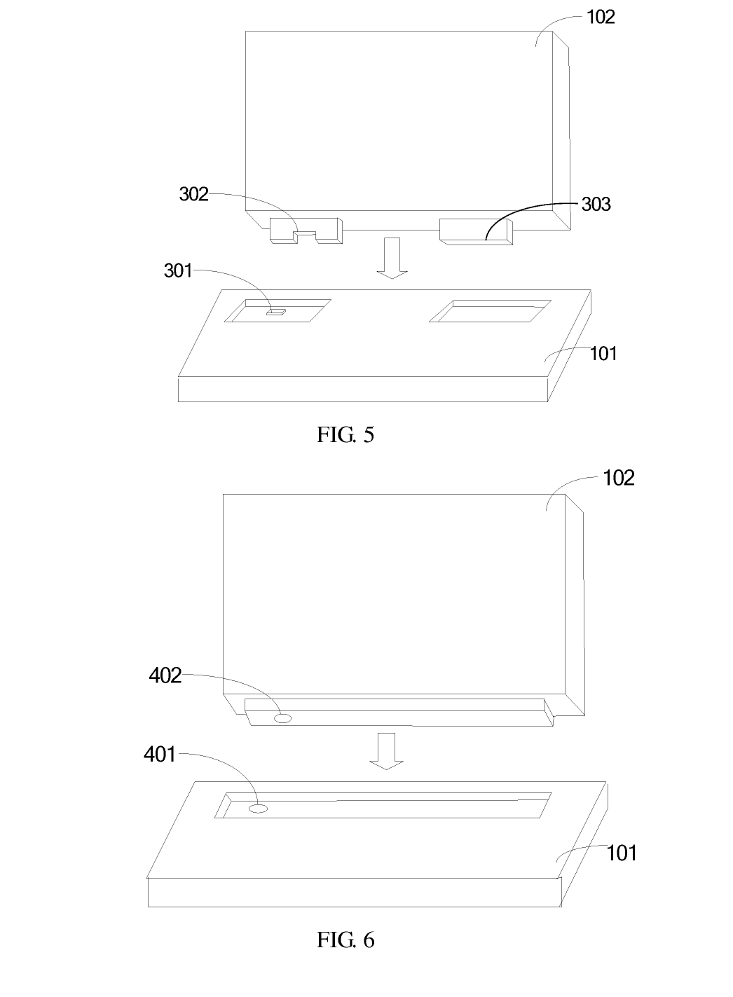

In the specific implementation process, referring to FIG. 5, which is the schematic view, in which the first positioning structure is the switch 301, and the second positioning structure is the groove structure 302 and the fixture block 303 with no groove structure. When the insertion module 102 is inserted into the base 101 in the first direction as shown in FIG. 5, since there is arranged the groove structure 302, the acting force applied to the switch 301 is smaller than the acting force threshold, and when the insertion module 102 is inserted into the base 101 in the second direction that is opposite to the first direction, since the fixture block 303 with no groove structure applies an acting force to the switch 301, the acting force applied to the switch 301 is greater than or equal to the acting force threshold. Alternatively, the second positioning structure is the switch, and the first positioning structure is the groove structure and the fixture block with no groove structure.

In the embodiment of the present invention, the first positioning structure is an embedded switch, and the second positioning structure is a protruded structure corresponding to the embedded switch and an fixture block with no protruded structure; or the second positioning structure is the embedded switch, and the first positioning structure is the protruded structure corresponding to the embedded switch and the fixture block with no protruded structure. Wherein when the acting force applied to the switch is greater than or equal to the acting force threshold, the switch outputs the trigger signal.

The action principle of arrangements of the embedded switches and the protruded structure mentioned above is similar to the action principle of arrangements of the switch and the groove structure.

### SECOND EMBODIMENT

In the second embodiment of the present application, an electronic device including a base and an insertion module is described, wherein the electronic device further includes:

a first positioning structure arranged at a first position on the base, wherein the first position is in the first engaged area of the base at which the base engaged with the insertion module when the insertion module is inserted into the base;

a second positioning structure arranged at a second position on the insertion module, wherein the second position is in the second engaged area of the insertion module at which the base is engaged with the insertion module, with the second position being corresponding to the first position; and

a determining unit connected to the first positioning structure or the second positioning structure.

Wherein during the approaching of the insertion module to the base, when the distance between first positioning structure and second positioning structure is smaller than or equal to a distance threshold, or when the acting force applied to the first positioning structure or second positioning structure is greater than or equal to an acting force threshold, the first positioning structure or second positioning structure outputs a trigger signal, such that the determining unit is enabled to determine a direction in which the insertion module is inserted into the base based on the trigger signal.

The electronic device of this embodiment includes the first engaged area, the second area and the storage unit described in the first embodiment above.

In the embodiment of the present application, the first position is on the first side of the first engaged area, and the second position is on the second side of the second engaged area corresponding to the first position, such that the distance between the first position and the second position is smaller than or equal to the distance threshold when the insertion module is engaged with the base in the first direction; and the distance between the first position and the second position is greater than the distance threshold when the insertion module is engaged with the base in the second direction that is different from the first direction.

In the electronic device of this embodiment, the arrangements of the first position and the second position may be the same as the arrangements of the first position and the second position in the first embodiment described above.

In the embodiment of the present application, the first positioning structure is a magnetic inductor, and the second positioning structure is a magnetic member; or the second positioning structure is the magnetic inductor, and the first positioning structure is the magnetic member. Wherein the magnetic inductor outputs the trigger signal when the distance between the magnetic inductor and the magnetic member is smaller than or equal to distance threshold.

In the process of the specific implementation, referring to FIG. 6, which illustrates that in the second embodiment of the present application, the first positioning structure is a magnetic member 401, and the second structure is a magnetic inductor 402. When the insertion module 102 is inserted into the base 101 in the first direction shown in FIG. 6, the distance between the magnetic inductor 402 and the magnetic member 401 is smaller than or equal to distance threshold, such that the magnetic member 401 is inducted by the magnetic inductor 402 which then outputs a trigger signal. However, when the insertion module 102 is inserted into the base in the second direction which is opposite to the first direction shown in FIG. 6, the distance between the magnetic inductor 402 and the magnetic member 401 is greater than the distance threshold, such that the magnetic inductor 402 cannot induct the magnetic member 401, and no trigger signal will be outputted. Alternatively, the second positioning structure is a magnetic member, and the first positioning structure is a magnetic inductor.

In the embodiment of the present application, the first positioning structure is a radio frequency structure, and the second positioning structure is a radio frequency identifying structure; or the second positioning structure is the radio frequency structure, and the first positioning structure is the radio frequency identifying structure. Wherein when the distance between the radio frequency identifying structure and the radio frequency structure is smaller than or equal to the distance threshold, the radio frequency identifying structure outputs the trigger signal.

The action principle of the arrangement of the radio frequency identifying structure and the radio frequency structure is similar with that of the arrangement of the magnetic inductor and the magnetic member.

### THIRD EMBODIMENT

In the third embodiment of the present application, an electronic device including a base and a insertion module described above, which further includes:

a first positioning structure arranged at the first position on the base, wherein the first position is in the first engaging area of the base at which the base is engaged with the insertion module when the insertion module is inserted into the base;

a second positioning structure arranged at the second position on the insertion module, wherein the second position is in the second engaging area of the insertion module at which the base is engaged with the insertion module, with the second position being corresponding to the first position; and

a determining unit connected to the first positioning structure or the second positioning structure.

Wherein during the approaching of the insertion module to the base, when the distance between the first positioning structure and the second positioning structure is smaller than or equal to the distance threshold, or when the acting force applied to either the first positioning structure or the second positioning structure is greater than or equal to the acting force threshold, the first positioning structure or the second positioning structure outputs a trigger signal such that the determining unit is enabled to determine a direction by which the insertion module is inserted into the base based on the trigger signal.

The electronic device in this embodiment includes the first engaging area, the second engaging area and the storage unit which are described in the first embodiment above.

In the embodiment of the present application, the first position is arranged in a first middle position of the first engaging area, and the second position is arranged in a second middle position of the second engaging area. Wherein the first positioning structure or the second positioning structure is asymmetric structure, such that when the insertion module is engaged with the base in a first direction, the acting force applied to the first or second positioning structure is greater than or equal to the acting force threshold; and when the insertion module is engaged with the base in a second direction that is different from the first direction, the acting force applied to the first or second positioning structure is smaller than the acting force threshold.

In the embodiment of the present application, the first positioning structure is a switch, and the second positioning structure is an asymmetric structure corresponding to the switch; or the second positioning structure is the switch, and the first positioning structure is the asymmetric structure corresponding to the switch. Wherein when the acting force applied to the switch is greater than or equal to the acting force threshold, the switch outputs the trigger signal.

In the embodiment of the present application, the asymmetric structure may be an asymmetric inverted trapezoidal structure, an asymmetric inverted stepped structure or an asymmetric inverted triangle structure.

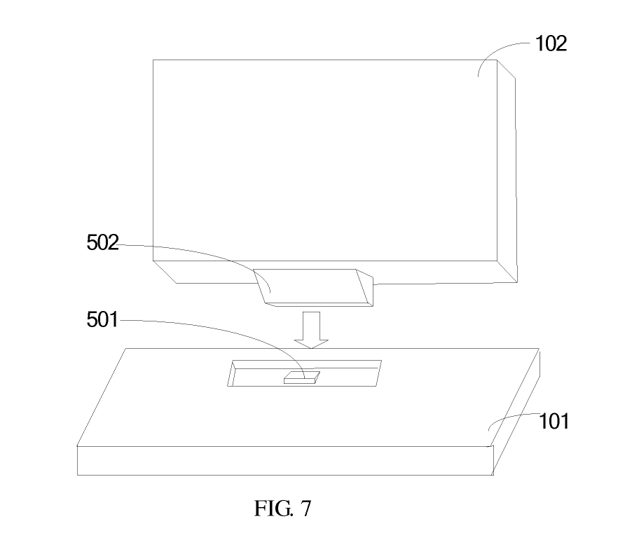

In the process of the specific implementation, referring to FIG. 7, which shows an example that the asymmetric structure is the asymmetric inverted trapezoidal structure to illustrate the action principle of the first positioning structure and the second positioning structure in the third embodiment: the first positioning structure is located in the any position of the first engaged area 201, which including the middle position of the first engaged area 201, wherein the first positioning structure is specifically an asymmetric triangle switch 501; while the second positioning structure is located in the middle position of the second engaged area 202, and the second positioning structure is specifically an asymmetric inverted trapezoidal structure 502. When insertion module 102 is inserted into the base 101 in the first direction shown in FIG. 7, the acting force applied to the asymmetric triangle switch 501 is smaller than the acting force threshold due to the arrangement of the asymmetric inverted trapezoidal structure 502; and when the insertion module 102 is inserted into the base in the second direction which is opposite to the first direction shown in FIG. 7, the side face of asymmetric inverted trapezoidal structure 502 acts on the asymmetric triangle switch 501 such that the acting force applied to the asymmetric triangle switch 501 is greater than or equal to the acting force threshold. Alternatively, the second positioning structure is specifically an asymmetric triangle switch, and the first positioning structure is specifically an asymmetric inverted trapezoidal structure.

Various modifications and variations can be made to the present invention by those skilled in the art without departing from the spirit and scope of the invention. Thus, if these modifications and variations of the present invention fall within the scope of the claims and the equivalents technical thereof, the present invention is also intended to include these modifications and variations.

1. A method of processing information which is applied to an electronic device, the electronic device comprising a first body and a second body, the first body comprising a first front face and a first back face which are opposite to each other, the second body comprising a second front face and a second back face which are opposite to each other, and the first body is adapted to be plugged into the second body, wherein the method comprises:
obtaining first gesture information of the first body when the first body is plugged into the second body, wherein the first gesture information is used to indicate a first direction of the first body;
obtaining second gesture information of the second body, wherein the second gesture information is used to indicate a second direction of the second body; and
determining, based on the first gesture information and the second gesture information, a plugging mode in which the first body is plugged into the second body, to obtain a first determination result, wherein the plugging mode is a normal plugging mode for indicating that the first front face is opposite to the second front face after the first body is plugged into the second body, or a reverse plugging mode for indicating that the first front face is opposite to the first back face after the first body is plugged into the second body.

2. The method as claimed in claim 1, wherein,
the obtaining the first gesture information of the first body comprises obtaining a first direction of a first left side face or a first right side face of the first body; and
the obtaining the second gesture information of the second body comprises obtaining a second direction of a second left side face or a second right side face of the second body;
wherein if the first direction is the direction of the first left side face, the second direction is the direction of the second left side face.

3. The method as claimed in claim 2, wherein the determining, based on the first gesture information and the second gesture information, a plugging mode in which the first body is plugged into the second body, to obtain a first determination result comprises:
based on the first direction and the second direction, determining whether the first direction is the same as or opposite to the second direction to obtain a second determination result; and
based on the second determination result, determining the plugging mode in which the first body is plugged into the second body, to obtain the first determination result,
wherein if the second determination result indicates that the first direction is the same as the second direction, the first determination result indicates that the plugging mode is the normal plugging mode; and
if the second determination result indicates that the first direction is opposite to the second direction, the first determination result indicates that the plugging mode is the reverse plugging mode.

4. The method as claimed in claim 1, wherein if the plugging mode is the normal plugging mode, after the determining, based on the first gesture information and the second gesture information, the plugging mode in which the first body is plugged into the second body, to obtain the first determination result, the method further comprises:
based on the first determination result, generating a first interface adjustment instruction to adjust a current user interface of the electronic device; and
executing the first interface adjustment instruction to adjust the current user interface into a first interface corresponding to the normal plugging mode.

5. The method as claimed in claim 1, wherein if the plugging mode is the reverse plugging mode, after the determining, based on the first gesture information and the second gesture information, the plugging mode in which the first body is plugged into the second body, to obtain the first determination result, the method further comprises:
based on the first determination result, generating a second interface adjustment instruction to adjust a current user interface of the electronic device; and
executing the second interface adjustment instruction to adjust the current user interface into a second interface corresponding to the reverse plugging mode.

6. An electronic device, comprising:
a first body comprising a first front face and a first back face which are opposite to each other;
a second body comprising a second front face and a second back face which are opposite to each other, wherein the first body is plugged into the second body;
a first direction sensor for obtaining first gesture information of the first body when the first body is plugged into the second body, wherein the first gesture information is used to indicate a first direction of the first body;
a second direction sensor for obtaining second gesture information of the second body, wherein the second gesture information is used to indicate a second direction of the second body; and
a processor for determining, based on the first gesture information and the second gesture information, a plugging mode in which the first body is plugged into the second body, to obtain a first determination result, wherein the plugging mode is a normal plugging mode for indicating that the first front face is opposite to the second front face after the first body is plugged into the second body, or a reverse plugging mode for indicating that the first front face is opposite to the first back face after the first body is plugged into the second body.

7. The electronic device as claimed in claim 6, wherein the first direction sensor is adapted to obtain a first direction of a first left side face or a first right side face of the first front face; and
the second direction sensor is adapted to obtain a second direction of a second left side face or a second right side face of the second body,
wherein if the first direction is the direction of the first left side face, the second direction is the direction of the second left side face.

8. The electronic device as claimed in claim 7, wherein the processor comprises:
a first determining unit for determining, based on the first direction and the second direction, whether the first direction is the same as or opposite to the second direction to obtain a second determination result; and
a second determining unit for determining, based on the second determination result, the plugging mode in which the first body is plugged into the second body, to obtain the first determination result,
wherein if the second determination result indicates the first direction is the same as the second direction, the first determination result indicates that the plugging mode is the normal plugging mode; and
if the second determination result indicates that the first direction is opposite to the second direction, the first determination result indicates that the plugging mode is the reverse plugging mode.

9. The electronic device as claimed in claim 6, further comprising:
a first generating unit for generating, based on the first determination result, a first interface adjustment instruction to adjust a current user interface of the electronic device; and
a first adjusting unit for executing the first interface adjustment instruction to adjust the current user interface into a first interface corresponding to the normal plugging mode.

10. The electronic device as claimed in claim 6, further comprising:
a second generating unit for generating, based on the first determination result, a second interface adjustment instruction to adjust a current user interface of the electronic device; and
a second adjusting unit for executing the second interface adjustment instruction to adjust the current user interface into a second interface corresponding to the reverse plugging mode.

11. An electronic device, comprising a base and an insertion module, wherein the electronic device further comprises:
a first positioning structure arranged at a first position on the base, wherein the first position is in a first engaging area of the base at which the base is engaged with the insertion module when the insertion module is inserted into the base;
a second positioning structure arranged at a second position on the insertion module, wherein the second position is in a second engaging area of the insertion module at which the base is engaged with the insertion module, with the second position being corresponding to the first position; and
a determining unit connected to the first positioning structure or the second positioning structure,
wherein during the approaching of the insertion module to the base, when the distance between the first positioning structure and the second positioning structure is smaller than or equal to a distance threshold, or when acting force applied to the first positioning structure or the second positioning structure is greater than or equal to an acting force threshold, the first positioning structure or the second positioning structure outputs a trigger signal, such that the determining unit may determine a direction in which the insertion module is inserted into the base based on the trigger signal.

12. The electronic device as claimed in claim 11, further comprising:
a storage unit connected to the determining unit, for pre-storing a corresponding relation between the trigger signal and the direction in which the insertion module is inserted into the base, such that the determining unit may determine the direction in which the insertion module is inserted into the base, according to the corresponding relation based on the trigger signal.

13. The electronic device as claimed in claim 11, wherein the first position is on a first side of the first engaging area, and the second position is on a second side of the second engaging area corresponding to the first position, such that:
when the insertion module is engaged with the base in a first direction, the acting force applied to the first positioning structure or the second positioning structure is greater than or equal to the acting force threshold; and
when the insertion module is engaged with the base in a second direction that is different from the first direction, the acting force applied to the first positioning structure or the second positioning structure is smaller than the acting force threshold.

14. The electronic device as claimed in claim 13, wherein the first positioning structure is a switch, and the second positioning structure is a groove structure arranged at a surface of the second engaging area corresponding to the switch; or
the second positioning structure is the switch, and the first positioning structure is the groove structure arranged at a surface of the first engaging area corresponding to the switch,
wherein if the acting force applied to the switch is greater than or equal to the acting force threshold, the switch outputs the trigger signal.

15. The electronic device as claimed in claim 13, wherein the first positioning structure is an embedded switch, and the second positioning structure is a protruded structure corresponding to the embedded switch; or
the second positioning structure is the embedded switch, and the first positioning structure is the protruded structure corresponding to the embedded switch,
wherein if the acting force applied to the switch is greater than or equal to the acting force threshold, the switch outputs the trigger signal.

16. The electronic device as claimed in claim 11, wherein the first position is on a first side of the first engaging area, and the second position is on a second side of the second engaging area corresponding to the first position, such that
when the insertion module is engaged with the base in a first direction, the distance between the first position and the second position is smaller than or equal to the distance threshold; and
when the insertion module is engaged with the base in a second direction that is different from the first direction, the distance between the first position and the second position is greater than the distance threshold.

17. The electronic device as claimed in claim 16, wherein the first positioning structure is a magnetic inductor, and the second positioning structure is a magnetic member; or
the second positioning structure is the magnetic inductor, and the first positioning structure is the magnetic member,
wherein if the distance between the magnetic inductor and the magnetic member is smaller than or equal to the distance threshold, the magnetic inductor outputs the trigger signal.

18. The electronic device as claimed in claim 16, wherein the first positioning structure is a radio frequency structure, and the second positioning structure is a radio frequency identifying structure; or
the second positioning structure is the radio frequency structure, and the first positioning structure is the radio frequency identifying structure;
wherein if the distance between the radio frequency identifying structure and the radio frequency structure is smaller than or equal to the distance threshold, the radio frequency identifying structure outputs the trigger signal.

19. The electronic device as claimed in claim 11, wherein the first position is on a first middle position of the first engaging area, and the second position is on a second middle position of the second engaging area, wherein the first positioning structure or the second positioning structure is an asymmetric structure, such that
when the insertion module is engaged with the base in a first direction, the acting force applied to the first positioning structure or the second positioning structure is greater than or equal to the acting force threshold; and
when the insertion module is engaged with the base in a second direction that is different from the first direction, the acting force applied to the first positioning structure or the second positioning structure is smaller than the acting force threshold.

20. The electronic device as claimed in claim 19, wherein the first positioning structure is a switch, and the second positioning structure is an asymmetric structure corresponding to the switch; or
the second positioning structure is the switch, and the first positioning structure is the asymmetric structure corresponding to the switch,
wherein if the acting force applied to the switch is greater than or equal to the acting force threshold, the switch outputs the trigger signal.
